(19) United States
(12) Patent Application Publication
(10) Pub. No.: US 2018/0307237 A1
(43) Pub. Date: Oct. 25, 2018

(54) VEHICLE AND METHOD FOR CONTROLLING THE SAME

(71) Applicants: Hyundai Kia Motor Company, Seoul (KR); Kia Motors Corporation, Seoul (KR)

(72) Inventor: Sungmin JI, Yongin-si (KR)

(73) Assignees: Hyundai Kia Motor Company, Seoul (KR); Kia Motors Corporation, Seoul (KR)

(21) Appl. No.: 15/682,177

(22) Filed: Aug. 21, 2017

(30) Foreign Application Priority Data
Apr. 19, 2017 (KR) 10-2017-0050254

(51) Int. Cl. G05D 1/02; G05D 3/12

(52) U.S. Cl. CPC G05D 1/0238; G05D 3/12

(57) ABSTRACT

A vehicle running on a road with a curved wall, may include a speed detector configured to detect driving speed of the vehicle; a capturer configured to detect lighting irradiated from a headlamp of the vehicle onto the wall and lighting irradiated from a headlamp of a target vehicle onto the wall; and a controller configured to determine a risk level of the vehicle colliding with the target vehicle based on a length that the lighting irradiated from the headlamp of the vehicle onto the wall moves and a length that the lighting irradiated from the headlamp of the target vehicle onto the wall moves when the vehicle is driven for a predetermined time, and control a driving route of the vehicle based on the determined risk level of collision.

### CROSS-REFERENCE TO RELATED APPLICATION

The present application claims priority to Korean Patent Application No. 10-2017-0050254, filed on Apr. 19, 2017, the entire contents of which is incorporated herein for all purposes by the present reference.

### BACKGROUND OF THE INVENTION

### Field of the Invention

The present invention relates to a vehicle and method for controlling the same, and more particularly to, a technology to avoid a collision of a vehicle by detecting a change in lighting area of the headlamp of an approaching vehicle from the opposite direction while the vehicle is driven on a road with a curved wall including an accessway to an underground parking lot.

### Description of Related art

Vehicles are driven on the roads or tracks to transport people or goods to destinations. The vehicle is able to move to various locations on one or more wheels mounted onto the frame of the vehicle. Such vehicles may be classified into three- or four-wheel vehicles, a two-wheel vehicle including a motorcycle, construction machinery, bicycles, trains traveling along rails on the tracks, and the like.

To relieve burdens and increase convenience of the driver, recent studies on vehicles provided with an Advanced Driver Assist System (ADAS) that actively provides information related to a state of the vehicle, a state of the driver, and surrounding conditions are actively ongoing.

As a part of this driver assist system, an auxiliary system for avoiding lane departure of a vehicle is being developed. Especially, for a moving vehicle that departs from the lane and is expected to collide with an opposite vehicle running from the opposite direction, a study on a lane departure avoidance system for a vehicle to avoid collision is being conducted. For example, as a lane keeping system to avoid a collision with the opposite vehicle running from the opposite direction, there may be, for example, a head-on collision avoidance system. The system intervenes aggressively in keeping a vehicle in the original lane when the vehicle departs from the lane and is expected to collide with the other vehicle running from the opposite direction thereof. When detecting unintended lane departure of the vehicle, the lane departure avoidance system assists the driver to stay in the lane by providing haptic feedback using the Motor Driven Power Steering (MDPS). Furthermore, it measures the lane with a front camera or the like, and assists the driver in safe driving by giving an alarm to the driver when detecting lane departure of the vehicle.

In the meantime, when a vehicle makes its way into an underground parking lot, the vehicle runs along a slope way with a curved wall to enter the parking lot. In the instant case, due to the curvature of the wall of the slope way, it is difficult for the driver of the vehicle to recognize an approaching vehicle from the opposite direction thereof. Moreover, since the accessway to the underground parking lot is typically narrow, when the vehicle is entering while departing from the lane, there is a risk of the vehicle colliding with the approaching vehicle from the opposite direction thereof. Accordingly, a need exists for a technology to rapidly recognize an approaching vehicle from the opposite direction when a vehicle is running a road with a curved including the accessway to the underground parking lot.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vehicle and method for controlling the same, and to, a technology to avoid a collision of a vehicle by promptly detecting a change in lighting area of the headlamp of an approaching vehicle from the opposite lane while the vehicle is moving on a road with a curved wall including an accessway to an underground parking lot.

In accordance with one aspect of the present invention, a vehicle may include a speed detector configured to detect driving speed of the vehicle, a capturer configured to detect lighting irradiated from a headlamp of the vehicle onto the wall and lighting irradiated from a headlamp of a target vehicle onto the wall, and a controller configured to determine a risk level of the vehicle colliding with the target vehicle based on a length that the lighting irradiated from the headlamp of the vehicle onto the wall moves and a length that the lighting irradiated from the headlamp of the target vehicle onto the wall moves when the vehicle is driven for a predetermined time, and control a driving route of the vehicle based on the determined risk level of collision.

The capturer may be configured to detect an end point of a lighting area irradiated from the headlamp of the vehicle onto the wall and an end point of a lighting area irradiated from the headlamp of the target vehicle onto the wall.

The capturer may be configured to detect an end point of a lighting area irradiated from the headlamp of the vehicle and moving on the wall while the vehicle is driven for the predetermined time, and detect an end point of a lighting area irradiated from the headlamp of the target vehicle and moving on the wall for the predetermined time with respect to the end point of the lighting area of the headlamp of the vehicle moving on the wall.

The controller may be configured to determine a driving distance traveled by the vehicle based on the detected driving speed and driving time of the vehicle.

The controller may be configured to determine a length that an end point of a lighting area irradiated from the headlamp of the vehicle onto the wall moves, based on the driving distance of the vehicle, a width of the vehicle, a width of a lane in which the vehicle is running, and a turning radius of the lane on which the vehicle is running.

The controller may be configured to determine a length that an end point of a lighting area of the headlamp of the target vehicle detected on the wall moves for the predetermined time, based on a distance between the end point of the lighting area of the headlamp of the vehicle and the end point of the lighting area of the headlamp of the target vehicle.

The controller may be configured to determine a risk level of the vehicle colliding with the target vehicle based on a difference between the length that the end point of the lighting area of the headlamp of the vehicle moves and the length that the end point of the lighting area of the headlamp of the target vehicle moves for the predetermined time.

The controller may be configured to determine that the target vehicle is at standstill when a difference between the length that the end point of the lighting area of the headlamp of the vehicle moves and the length that the end point of the lighting area of the headlamp of the target vehicle moves for the predetermined time is zero.

The controller may be configured to send a signal for lane departure avoidance control for the vehicle, when the determined risk level of collision is higher than a predetermined value.

In accordance with another aspect of the present invention, a method for controlling a vehicle may include detecting lighting irradiated from a headlamp of the vehicle onto the wall and lighting irradiated from a headlamp of a target vehicle onto the wall, determining a length that the lighting irradiated from the headlamp of the vehicle onto the wall moves while the vehicle is driven for a predetermined time, determining a length that the lighting irradiated from the headlamp of the target vehicle onto the wall moves, determining a risk level of the vehicle colliding with the target vehicle based on the length that the lighting irradiated from the headlamp of the vehicle onto the wall moves and the length that the lighting irradiated from the headlamp of the target vehicle onto the wall moves; and controlling a driving route of the vehicle based on the determined risk level of collision.

The detecting lighting irradiated from a headlamp onto the wall may include: detecting an end point of a lighting area irradiated from the headlamp of the vehicle onto the wall and an end point of a lighting area irradiated from the headlamp of the target vehicle onto the wall.

The detecting lighting irradiated from a headlamp onto the wall may include: detecting an end point of a lighting area irradiated from the headlamp of the vehicle and moving on the wall, while the vehicle is driven for the predetermined time, and detecting an end point of a lighting area irradiated from the headlamp of the target vehicle and moving on the wall for the predetermined time with respect to the end point of the lighting area of the headlamp of the vehicle moving on the wall.

The method for controlling a vehicle may further include: detecting driving speed of the vehicle, and determining a driving distance traveled by the vehicle based on the detected driving speed and driving time of the vehicle.

The determining a length that the lighting irradiated from the headlamp of the vehicle onto the wall moves may include: determining a length that an end point of a lighting area irradiated from the headlamp of the vehicle onto the wall moves, based on the driving distance of the vehicle, a width of the vehicle, a width of a lane in which the vehicle is running, and a turning radius of the lane on which the vehicle is running.

The determining a length that the lighting irradiated from the headlamp of the vehicle onto the wall moves may include: determining a length that an end point of a lighting area of the headlamp of the target vehicle detected on the wall moves for the predetermined time, based on a distance between the end point of the lighting area of the headlamp of the vehicle and the end point of the lighting area of the headlamp of the target vehicle.

The determining a risk level of the vehicle colliding with the target vehicle may include: determining a risk level of the vehicle colliding with the target vehicle based on a difference between the length that the end point of the lighting area of the headlamp of the vehicle moves and the length that the end point of the lighting area of the headlamp of the target vehicle moves for the predetermined time.

The determining a risk level of the vehicle colliding with the target vehicle may include: determining that the target vehicle is at standstill when a difference between the length that the end point of the lighting area of the headlamp of the vehicle moves and the length that the end point of the lighting area of the headlamp of the target vehicle moves for the predetermined time is zero.

The controlling a driving route of the vehicle may include: sending a signal for lane departure avoidance control for the vehicle, when the determined risk level of collision is higher than a predetermined value.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view schematically illustrating the external of a vehicle, according to an exemplary embodiment of the present invention;

FIG. 2 shows internal features of a vehicle, according to an exemplary embodiment of the present invention;

FIG. 3 is a control block diagram of a vehicle, according to an exemplary embodiment of the present invention;

FIG. 4 and FIG. 5 are conceptual diagrams for a vehicle to determine a distance that lighting irradiated from the headlight of a stopped target vehicle onto a wall moves as the vehicle moves, according to an exemplary embodiment of the present invention;

FIG. 6 shows detection of a lighting area irradiated from the headlamp of the target vehicle onto the curved wall in the case of FIG. 4 and FIG. 5;

FIG. 7 and FIG. 8 are conceptual diagrams for a vehicle to determine a distance that lighting irradiated from the headlamp of a moving target vehicle onto a wall moves as the vehicle moves, according to an exemplary embodiment of the present invention;

FIG. 9 shows detection of a lighting area irradiated from the headlamp of the target vehicle onto a curved wall in the case of FIGS. 7 and 8;

FIG. 10 shows controlling a driving route of a vehicle when there is a risk of the vehicle colliding with a target vehicle, according to an exemplary embodiment of the present invention; and

FIG. 11 is a flowchart illustrating a method for controlling a vehicle, according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION OF EXEMPLARY EMBODIMENTS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Like numerals refer to like elements throughout the specification. Not all elements of embodiments of the present invention will be described, and description of what are commonly known in the art or what overlap each other in the exemplary embodiments will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

The term “include (or including)” or “comprise (or comprising)” is inclusive or open-ended and does not exclude additional, unrecited elements or method steps, unless otherwise mentioned.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or portion from another region, layer or section.

It is to be understood that the singular forms “a,” “an,” and “the” include plural references unless the context clearly dictates otherwise.

Reference numerals used for method steps are just used for convenience of explanation, but not to limit an order of the steps. Thus, unless the context clearly dictates otherwise, the written order may be practiced otherwise.

The principle and embodiments of the present invention will now be described with reference to accompanying drawings.

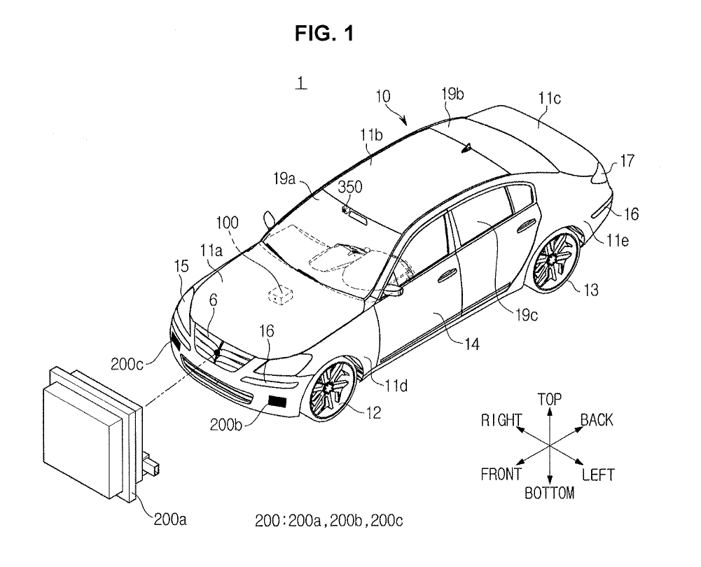

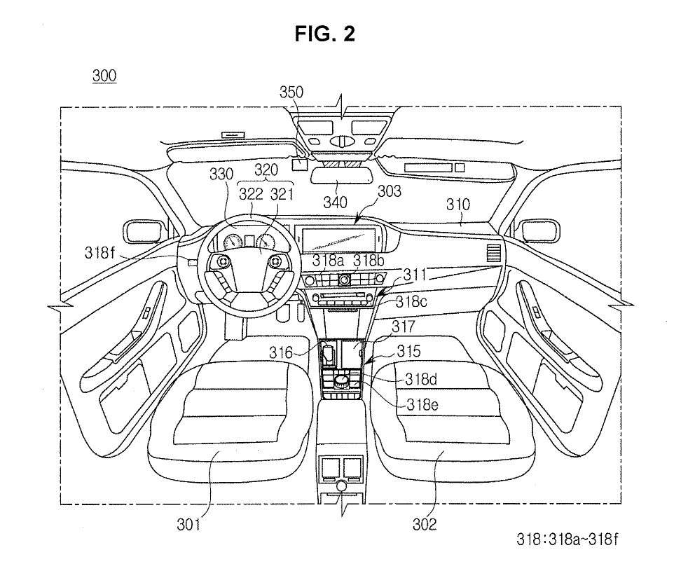

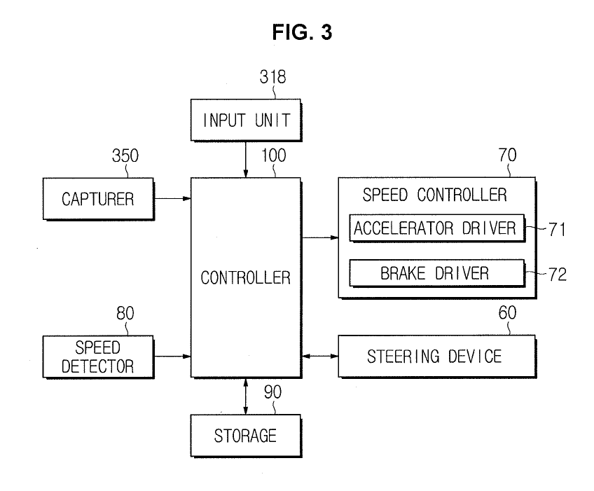

FIG. 1 is a perspective view schematically illustrating the external of a vehicle, according to an exemplary embodiment of the present invention. FIG. 2 shows internal features of a vehicle, according to an exemplary embodiment of the present invention, and FIG. 3 is a control block diagram of a vehicle, according to an exemplary embodiment of the present invention.

For convenience of explanation, as shown in FIG. 1, a direction in which a vehicle 1 advances is called a forward direction, and left and right directions are distinguished based on the forward direction thereof. When the forward direction corresponds to the twelve o'clock position, the right direction is defined to correspond to the three o'clock position or around the three o'clock position, and the left direction is defined to correspond to the nine o'clock position or around the nine o'clock position. The opposite direction of the forward direction is the rear direction thereof. Also, a direction down to the floor of the vehicle 1 is called a downward direction, and a direction opposite to the downward direction is called an upward direction thereof. Furthermore, a side located ahead is called a front side, a side located behind is called a rear side, and sides located on either side are called sides. The sides include left and right sides.

Referring to FIG. 1, a vehicle 1 may include a vehicle body 10 that forms the external, and wheels 12, 13 for moving the vehicle 1.

The vehicle body 10 may include a hood 11a for protecting various devices required for driving the vehicle 1, a roof panel 11b that forms an indoor space, a trunk lid 11c of a trunk, front fenders 11d disposed on the sides of the vehicle 1, and quarter panels 11e. There may be a plurality of doors 15 disposed on the sides of the vehicle body 10 and hinged with the vehicle body 10.

A front window 19a is disposed between the hood 11a and the roof panel 11b for providing a view ahead of the vehicle 1, and a rear window 19b is disposed between the roof panel 11b and the trunk lid 11c for providing a view behind the vehicle 1. Side windows 19c may also be built into the upper portion of the doors 15 to provide side views.

Headlamps 15 may be disposed on the front of the vehicle 1 for lighting a direction in which the vehicle 1 advances. The headlamps 15 may irradiate light forward of the vehicle 1 to help the driver identify an obstruction located in front of the vehicle 1. Especially, when the vehicle 1 is driven on a dark and narrow road including entering into an underground parking lot, it may irradiate light with the headlamps 15 to easily identify an obstruction and the road in front of the vehicle 1.

Turn signal lamps 16 may also be disposed on the front and back of the vehicle 1 for indicating a direction to which the vehicle 1 is going to make a turn.

The vehicle 1 may blink the turn signal lamp 16 to indicate a direction to turn to. Tail lamps 17 may also be disposed on the back of the vehicle 1. The tail lamps 17 may indicate a state of gear shift, a state of brake operation of the vehicle 1, etc.

As shown in FIG. 1 and FIG. 2, at least one capturer 350 may be disposed inside the vehicle 1. The capturer 350 may capture an image around the vehicle 1 while the vehicle is being driven or stopped, and further obtain information related to a type and position of the object.

The capturer 350 may detect lighting irradiated from the headlamp 15 of the vehicle 1 or even from another vehicle onto a wall.

While the vehicle is running on a road with a curved wall including an underground parking lot, the light irradiated from the headlamp 15 of the vehicle 1 is projected onto the wall. At the present time, the capturer 350 may capture an image in front of the vehicle 1 to detect lighting of the headlamp 15 projected onto the wall.

The capturer 350 may detect a lighting area irradiated from the headlamp 15 onto the wall, and detect the shape or end point of the lighting area.

The capturer 350 may capture an image of the surroundings of the vehicle 1 to detect the condition of the road on which the vehicle 1 is running. For example, it may detect the width of a road on which the vehicle 1 is driven or a turning radius of a road with a curved wall based on the captured image.

The capturer 350 may capture an image of the surroundings of the vehicle 1, obtain the aforementioned data based on a result of image recognition of the captured image, and send the data to a controller 100. The data obtained by the capturer 350 may also be stored in a storage 90.

While FIG. 2 shows the capturer 350 disposed around a rear view mirror 340, the capturer 350 may be provided at any place that allows the capturer 350 to obtain image information by capturing inside or outside of the vehicle 1.

The capturer 350 may include at least one camera, and further include a three dimensional (3D) space recognition sensor, radar sensor, ultrasound sensor, etc., to capture a more accurate image. For the 3D space recognition sensor, a KINECT (RGB-D sensor), TOF (Structured Light Sensor), stereo camera, or the like may be used, without being limited thereto, and any other devices having the similar function may also be used.

Referring to FIG. 2, in an internal 300 of the vehicle 1, there are a driver seat 303, a passenger seat 304, a dashboard 310, a wheel 320, and an instrument panel 330.

The dashboard 310 refers to a panel that separates the internal room from the engine compartment and that has various parts required for driving disposed thereon. The dashboard 310 is located in front of the driver seat 303 and passenger seat 304. The dashboard 310 may include a top panel, a center fascia 311, a gear box 315, and the like.

On the top panel of the dashboard 310, a display 303 may be disposed. The display 303 may present various information in a form of images to the driver or passenger of the vehicle 1. For example, the display 303 may visually present various information including maps, weather, news, various moving or still images, information regarding status or operation of the vehicle 1, e.g., information related to the air conditioner, etc. Furthermore, the display 303 may provide the driver or passenger with an alert corresponding to a level of danger to the vehicle 1. When the vehicle 1 is about to change lanes, different alerts may be provided to the driver according to different levels of danger. The display 303 may be implemented with a commonly-used navigation system.

The display 303 may be disposed inside a housing integrally or monolithically formed with the dashboard 310 such that the display 301 may be exposed. Alternatively, the display 303 may be disposed in the middle or the lower portion of the center fascia 311, or may be disposed on the internal to the windshield or on the top portion of the dashboard 310 by a separate supporter. Besides, the display 303 may be disposed at any position that may be considered by the designer.

Behind the dashboard 310, various types of devices including a processor, a communication module, a Global Positioning System (GPS) module, a storage, etc., may be disposed. The processor disposed in the vehicle 1 may be configured to control various electronic devices disposed in the vehicle 1, and is configured as the controller 100. The aforementioned devices may be implemented using various parts including semiconductor chips, switches, integrated circuits, resistors, volatile or nonvolatile memories, printed circuit boards (PCBs), and/or the like.

The center fascia 311 may be disposed in the middle of the dashboard 310, and may have input device 318a to 318c for inputting various instructions related to the vehicle 1. The input device 318a to 318c may be implemented with mechanical buttons, knobs, a touch pad, a touch screen, a stick-type manipulation device, a trackball, or the like. The driver may control many different operations of the vehicle 1 by manipulating the input device 318a to 318c.

The gear box 315 is located below the center fascia 311 between the driver seat 301 and the passenger seat 302. In the gear box 315, a transmission 316, a container box 317, various input device 318d to 318e, etc., are included. The input device 318d to 318e may be implemented with mechanical buttons, knobs, a touch pad, a touch screen, a stick-type manipulation device, a trackball, or the like. The container box 317 and input device 318d to 318e may be omitted in various exemplary embodiments.

The wheel 320 and an instrument panel 330 are located on the dashboard 310 in front of the driver seat 303.

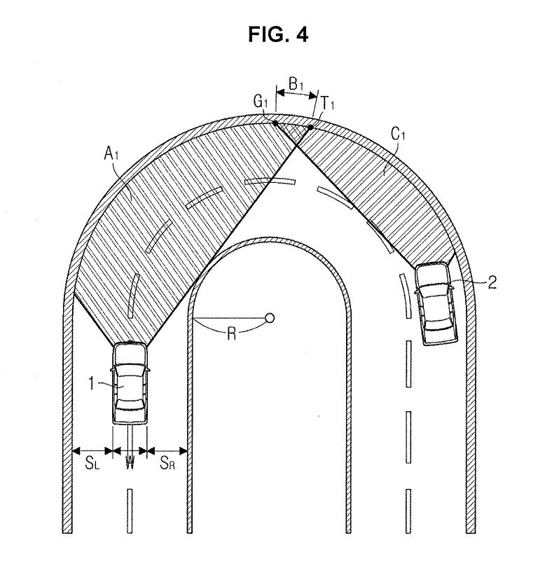

The wheel 320 may be rotated in a certain direction by manipulation of the driver, and accordingly, the front or back wheels of the vehicle 1 are rotated, steering the vehicle 1. The wheel 320 includes a spoke 321 connected to a rotation shaft and a steering wheel 322 combined with the spoke 321. On the spoke 321, there may be an input device for inputting various instructions, and the input device may be implemented with mechanical buttons, knobs, a touch pad, a touch screen, a stick-type manipulation device, a trackball, or the like. The steering wheel 322 may have a radial form to be conveniently manipulated by the driver, but is not limited thereto. Internal to at least one of the spoke 321 and the steering wheel 322, a vibrator 201 (in FIG. 4) may be disposed for allowing at least one of the spoke 321 and the steering wheel 322 to vibrate at a certain intensity according to an external control signal. In various exemplary embodiments, the vibrator 201 may vibrate at various intensities according to external control signals, and accordingly, at least one of the spoke 321 and the steering wheel 322 may vibrate at various intensities. With the function of the vibrator 201, the vehicle 1 may provide haptic alerts for the driver. For example, at least one of the spoke 321 and the steering wheel 322 may vibrate to an extent that corresponds to a level of danger determined when the vehicle 1 changes lanes. In the present way, various alerts may be provided to the driver. The higher the level of danger is, the stronger the at least one of the spoke 321 and the steering wheel 322 vibrates to provide a high level of alert to the driver.

Furthermore, a turn signal indicator input device 318f may be disposed in the back of the wheel 320. The user may input a signal to change driving direction or lanes through the turn signal indicator input device 318f while driving the vehicle 1.

The instrument panel 330 is formed to provide the driver with various information relating to the vehicle 1 including speed of the vehicle 1, engine rpm, fuel left, temperature of engine oil, flickering of turn signals, a distance traveled by the vehicle, etc. The instrument panel 330 may be implemented with lights, indicators, or the like, and it may be implemented with a display panel as well, in various exemplary embodiments. In the case that the instrument panel 330 is implemented with the display panel, in addition to the aforementioned information, the instrument panel 330 may provide other various information including gas mileage, whether various functions of the vehicle 1 are performed, or the like to the driver by displaying them. The instrument panel 330 may output and provide different alerts for the user based on different levels of danger to the vehicle 1. When the vehicle 1 changes lanes, the instrument panel 330 may provide different alerts to the driver based on differently determined levels of danger.

Referring to FIG. 4, the vehicle 1 in an exemplary embodiment of the present invention may include a steering device 60 for controlling steering of the vehicle 1, a speed controller 70 for controlling the driving speed of the vehicle 1 driven by the driver, a speed detector 80 for detecting the driving speed of the vehicle 1, the storage 90 for storing data related to the control of the vehicle 1, and the controller 100 for controlling the respective components of the vehicle 1 and the driving speed of the vehicle 1.

The steering device 60 may be disposed on the steering wheel 322 or the rotation shaft connected to the steering wheel 322 for detecting a steering input according to manipulation of the steering wheel 322, detecting a steering angle and steering torque, and sending the detected results to the controller 100. The controller 100 may recognize a driving direction and driving route of the vehicle 1 based on the received steering angle and steering torque. The controller 100 may also send a signal to control steering of the vehicle 1, and the steering device 60 may control the driving route by receiving the signal.

The speed controller 70 may control the speed of the vehicle 1 driven by the driver. The speed controller 70 may include an accelerator driver 71 and a brake driver 71.

The accelerator driver 71 may increase speed of the vehicle 1 by activating the accelerator upon reception of a control signal from the controller 100, and the brake driver 72 may decrease speed of the vehicle by activating the brake upon reception of a control signal from the controller 100.

The controller 100 may increase or decrease the driving speed of the vehicle 1 to increase or decrease the distance between the vehicle to an object based on the distance between the vehicle 1 and the object and a predetermined reference distance stored in the storage 90.

Furthermore, the controller 100 may determine an estimated collision time ITC of the vehicle 1 against the object based on relative distance and relative speed between the vehicle 1 and the object, and may send a signal to control the driving speed of the vehicle 1 to the speed controller 70 based on the determined TTC.

The speed controller 70 may control the driving speed of the vehicle 1 under the control of the controller 100, and may decrease the driving speed of the vehicle 1 when the risk of collision between the vehicle 1 and another vehicle is high.

The speed controller 80 may detect the driving speed of the vehicle 1 driven by the driver under the control of the controller 100. It may detect the driving speed using the rotation speed of the wheels of the vehicle 1, and a unit of the driving speed may be represented in kph, meaning a distance (km) traveled per unit hour (h).

The storage 90 may store various data related to the control of the vehicle 1. In an embodiment, the storage 90 may store information related to driving speed, distance, and time traveled by the vehicle 1, and further store image recognition data of an image about the surroundings of the vehicle 1, which is captured by the capturer 350.

In addition, the storage 90 may store data related to mathematical formulas and control algorithms used in controlling the vehicle 1 in an embodiment, and the controller 1 may send control signals to control the vehicle 1 according to the formulas and control algorithms.

The storage 90 may be implemented with at least one of a non-volatile memory device including cache, read only memory (ROM), programmable ROM (PROM), erasable programmable ROM (EPROM), electrically erasable programmable ROM (EEPROM), a volatile memory device including random access memory (RAM), or a storage medium including hard disk drive (HDD) or compact disk (CD) ROM, without being limited thereto. The storage 90 may be a memory implemented with a chip separate from the aforementioned processor in relation to the controller 100, or may be implemented integrally with the processor in a single chip.

Turning back to FIGS. 1 and 3, at least one controller 100 may be disposed inside the vehicle 1. The controller 100 may perform electronic control over the respective components associated with operation of the vehicle 1.

The controller 100 may determine a risk level of collision between the vehicle 1 and a target vehicle 2 based on a distance that the lighting from the headlamp 15 of the vehicle 1 irradiated onto the wall has moved and a distance that the lighting irradiated from the headlamp of the target vehicle 2 onto the wall has moved.

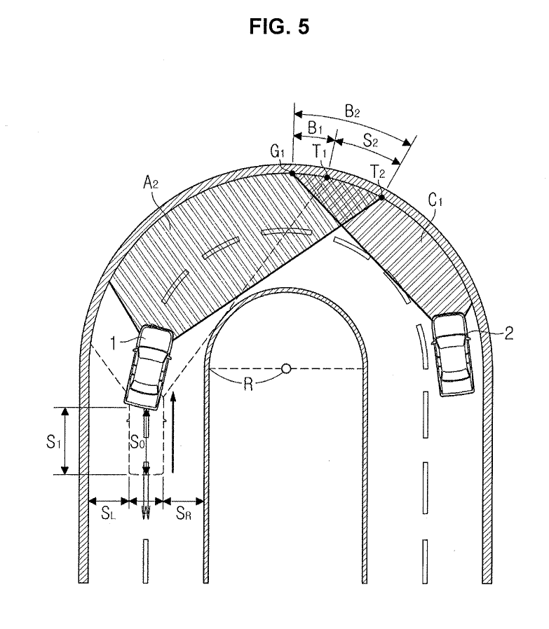

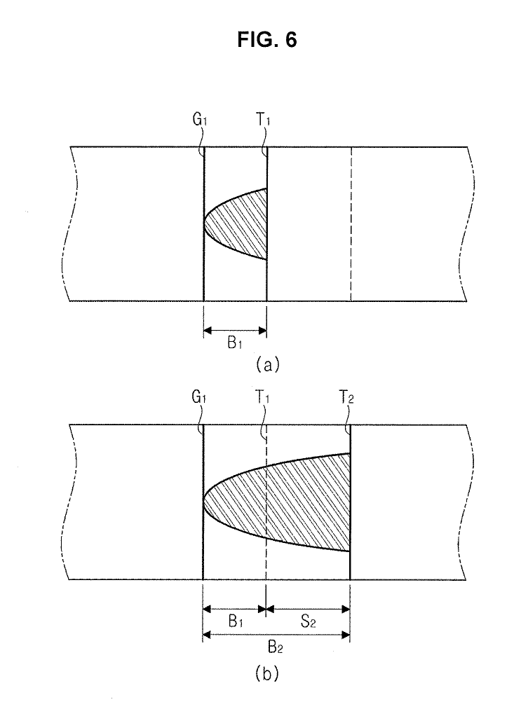

FIG. 4 and FIG. 5 are conceptual diagrams for a vehicle to determine a distance that lighting irradiated from the headlight of a stopped target vehicle onto a wall moves as the vehicle moves, according to an exemplary embodiment of the present invention. FIG. 6 shows detection of a lighting area irradiated from the headlamp of the target vehicle onto the curved wall in the case of FIG. 4 and FIG. 5.

Referring to FIG. 4, when a vehicle 1 is driven on a road with a curved wall, the headlamp 15 may irradiate light forward thereof. As shown in FIG. 4, the vehicle 1 may not detect the target vehicle 2 that is running from the opposite direction of the road with the curved wall. For example, when the wall has a large curvature, a detection detector of the vehicle 1 may not detect the target vehicle 2 even when the vehicle 1 and the target vehicle 2 approach to each other.

In an exemplary embodiment of the present invention, the capturer 350 provided in the vehicle 1 may detect lighting irradiated from the headlamp of the target vehicle 2 onto the wall to detect a change in length or area of the headlamp lighting of the target vehicle 2 as the vehicle 1 moves.

When the headlamp 15 of the vehicle 1 irradiates light, the capturer 350 may detect an end point T₁ of a lighting area A₁ irradiated from the headlamp 15 of the vehicle 1 onto the wall. It may also detect an end point G₁ of a lighting area C₁ irradiated from the headlamp of the target vehicle 2 onto the wall.

As shown in FIG. 4, when the capturer 350 of the vehicle 1 detects the lighting irradiated from the headlamp of the target vehicle 2 onto the wall, a length B₁ from the end point T₁ of the lighting area A₁ of the headlamp 15 of the vehicle 1 to the end point G₁ of the lighting area C₁ of the headlamp of the target vehicle 2 may be determined.

Furthermore, the capturer 350 may detect widths S_{L} and S_{R} of left and right lanes, respectively, and a turning radius R of the road on which the vehicle 1 is running.

Referring to FIG. 5, while the vehicle 1 is running on the road, the lighting area irradiated from the headlamp 15 of the vehicle 1 onto the wall is changed and the capturer 350 may detect an end point T₂ of the changed lighting area A₂.

The position itself of the lighting irradiated from the headlamp of the target vehicle 2 is not changed when the target vehicle 2 is stopped, but the position of the lighting irradiated from the headlamp 15 of the vehicle 1 is changed when the vehicle 1 is running, so the end point G₁ of the lighting area C₁ of the target vehicle 2 to be detected by the capturer 350 is changed as well.

As shown in FIG. 5, as the vehicle 1 moves, the end point of the lighting area of the headlamp 15 of the vehicle 1 is changed from T₁ to T₂, and accordingly, the length from the end point T₂ of the lighting area A₂ of the headlamp 15 of the vehicle 1 to the end point G₁ of the lighting area C₁ of the headlamp of the target vehicle 2 is changed from B₁ to B₂.

That is, as the vehicle 1 moves, the position of the lighting irradiated from the headlamp 15 of the vehicle 1 onto the wall is moved the length S₂ on the wall. While the target vehicle 2 is stopped, the distance between the end point of the lighting area of the headlamp 15 of the vehicle 1 and the end point of the lighting area of the headlamp of the target vehicle 2 increases in proportion to the distance moved by the vehicle 1.

Referring to FIG. 6, (a) shows that when the vehicle 1 is located at the position of FIG. 4, the distance between the end point T₁ of the lighting area A₁ of the headlamp 15 of the vehicle 1 and the end point G₁ of the lighting area C₁ of the headlamp of the target vehicle 2 is B₁. (b) shows that when the vehicle 1 is driven for a certain time, the distance between the end point T₂ of the lighting area A₂ of the headlamp 15 of the vehicle 1 and the end point G₁ of the lighting area C₁ of the headlamp of the target vehicle 2 is B₂.

That is, as the vehicle 1 moves, the capturer 350 may detect the lighting area that is irradiated from the headlamp of the target vehicle 2 and moved the length S₂ on the wall.

Referring to FIG. 5, when the vehicle 1 has moved the distance S₀ on the road for a predetermined time, a distance moved by the vehicle 1 along a trajectory on the wall is S₁. Since the circular road with a curved wall has a constant curvature, it may be assumed that the distance S₁ moved by the vehicle 1a long the trajectory on the wall is equal to the length S₂ that the end point of the lighting area of the headlamp 15 of the vehicle 1 has moved from T₁ to T₂.

Although the vehicle 1 is shown to move on a straight road and so the lengths S₀ and S₁ are represented equally in FIG. 5, when the vehicle 1 is driven on a curved road, the lengths S₀ and S₁ are not equal but in proportion to the turning radius R of the road.

Accordingly, as the vehicle 1 moves, the controller 100 may determine the length that the end point of the lighting area irradiated from the headlamp of the target vehicle 2 onto the wall moves from the end point of the lighting area of the headlamp 15 of the vehicle 1.

The controller 100 may determine the distance S₀ traveled by the vehicle 1 on the road based on the driving speed V_{E} and driving time T of the vehicle 1 as in the following equation 1:

S₀=V_{E}* T (1)

The controller 100 may determine the distance S₁ moved by the vehicle 1 along the trajectory on the wall based on the determined distance S₀ traveled by the vehicle 1, as in the following proportional expression:

S₀:R+S_{R}+W/2=S:R+S_{R}+S_{L}+W (2)

where S_{R} and S_{L} respectively denote the right lane width and the left lane width of the road on which the vehicle 1 is running, and W denotes the width of the vehicle.

The controller 100 may determine S₁ based on the relation of equations 1 and 2.

Furthermore, the controller 100 may determine a length of a change in lighting area of the headlamp of the target vehicle 2 that may be detected by the capturer 350 as the end point of the lighting area of the headlamp 15 of the vehicle 1 is moved from T₁ to T₂ while the vehicle 1 is running for a predetermined time. For example, as described above, as the vehicle 1 moves, the lighting area of the headlamp of the target vehicle 2 that may be detected by the capturer 350 increases by S₂.

The controller 100 may determine a difference S₂ between the distance B₂ between the end point T₂ of the lighting area A₂ of the headlamp 15 of the vehicle 1 and the end point G₁ of the lighting area C₁ of the headlamp of the target vehicle 2 after the vehicle 1 is driven for a predetermined time and the distance B₁ between the end point T₁ of the lighting area A₁ of the headlamp 15 of the vehicle 1 and the end point G₁ of the lighting area C₁ of the headlamp of the target vehicle 2 before the vehicle 1 is driven. Furthermore, the controller 100 may compare the difference S₂ with S₁ determined by the equations 1 and 2.

While the target vehicle 2 is stopped, when the vehicle 1 is running for a predetermined time, the length of the lighting area irradiated from the headlamp of the target vehicle 2 and detected by the capturer 350 of the vehicle 1 is changed as much as the distance S₁ moved by the vehicle 1 along the trajectory on the wall.

Accordingly, the controller 100 may determine whether the target vehicle 2 is stopped or moving based on the difference between the length S₁ that the end point of the lighting area of the headlamp 15 of the vehicle 1 is moved and the length S₂ of a change in lighting area of the headlamp of the target vehicle 2 detected by the capturer 350.

Since FIG. 4, FIG. 5 and FIG. 6 show an occasion when the target vehicle 2 is stopped, the length S₁ that the end point of the lighting area of the headlamp 15 of the vehicle 1 is moved is the same as the length S₂ of a change in lighting area of the headlamp of the target vehicle 2 detected by the capturer 350, and so the difference is zero. The controller 100 may determine that the target vehicle 2 is stopped when the difference in length is zero, and in the instant case, determine the risk level of collision to be low because it would be easy for the driver of the vehicle 1 to spot the target vehicle 2 and perform collision avoidance control.

A risk level threshold of collision between the vehicle 1 and the target vehicle 2 is set in advance and stored in the storage 90, and may be changed by taking into account driving routes, driving speeds, and time to collision of the vehicle 1 and the target vehicle 2.

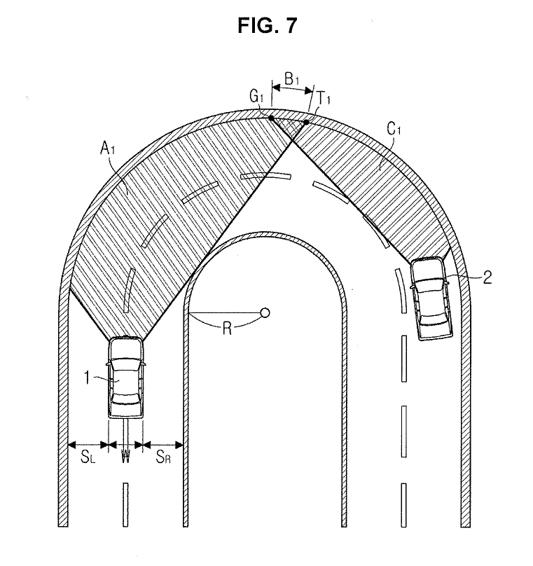

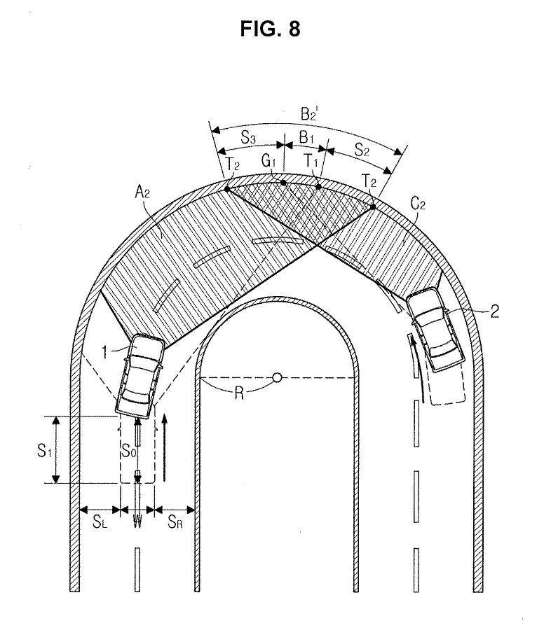

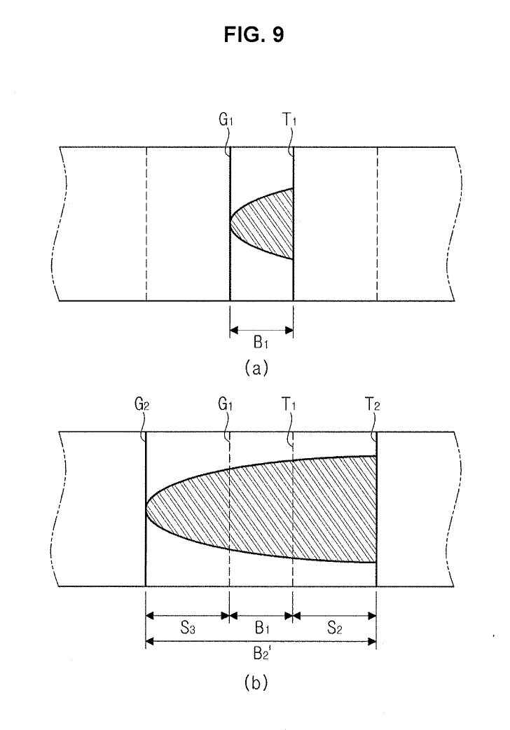

FIG. 7 and FIG. 8 are conceptual diagrams for a vehicle to determine a distance that lighting irradiated from the headlamp of a moving target vehicle onto a wall moves as the vehicle moves, according to an exemplary embodiment of the present invention. FIG. 9 shows detection of a lighting area irradiated from the headlamp of the target vehicle onto a curved wall in the case of FIGS. 7 and 8.

Referring to FIG. 7, when the vehicle 1 is driven on a road with a curved wall, the headlamp 15 may irradiate light forward thereof.

When the headlamp 15 of the vehicle 1 irradiates light, the capturer 350 may detect the end point T₁ of the lighting area A₁ irradiated from the headlamp 15 of the vehicle 1 onto the wall 15, as described above with reference to FIG. 4. It may also detect the end point G₁ of the lighting area C1 irradiated from the headlamp of the target vehicle 2 onto the wall.

As shown in FIG. 7, when the capturer 350 of the vehicle 1 detects the lighting irradiated from the headlamp of the target vehicle 2 onto the wall, a length B₁ from the end point T₁ of the lighting area A₁ of the headlamp 15 of the vehicle 1 to the end point G₁ of the lighting area C₁ of the headlamp of the target vehicle 2 may be determined.

Furthermore, the capturer 350 may detect widths S_{L} and S_{R} of left and right lanes, respectively, and a turning radius R of the road on which the vehicle 1 is running.

Referring to FIG. 8, while the vehicle 1 is running on the road, the lighting area of the headlamp 15 irradiated from the vehicle 1 onto the wall is changed and the capturer 350 may detect the end point T2 of the changed lighting area A2.

When the target vehicle 2 is moving, the position itself of the lighting irradiated from the headlamp of the target vehicle 2 is changing as well, and at the same time, the lighting area irradiated from the headlamp 15 of the vehicle 1 is also changing.

Accordingly, the lighting area irradiated from the headlamp 15 of the vehicle 1 is changed from A₁ to A₂, and thus the end point of the lighting area of the headlamp 15 of the vehicle 1 is changed from T₁ to T₂. Furthermore, since the vehicle 1 and the target vehicle are moving at the same time, the lighting area irradiated from the headlamp of the target vehicle 2 also changes from C₁ to C₂, and thus the end point of the lighting area of the headlamp of the target vehicle 2 changes from G₁ to G₂.

As shown in FIG. 8, as the vehicle 1 moves, the end point of the lighting area of the headlamp 15 of the vehicle 1 is changed from T₁ to T₂, and the end point of the lighting area of the headlamp of the target vehicle 2 is changed from G₁ to G₂, and accordingly, the length from the end point T₂ of the lighting area A₂ of the headlamp 15 of the vehicle 1 to the end point G₂ of the lighting area C₂ of the headlamp of the target vehicle 2 is changed from B₁ to B₂′.

In other words, as the vehicle 1 and the target vehicle 2 move, the position of the end point of the lighting irradiated from the headlamp 15 of the vehicle 1 onto the wall is moved the length S₂ on the wall, and the position of the end point of the lighting irradiated from the headlamp of the target vehicle 2 onto the wall is moved the length S₃ as well.

Referring to FIG. 9, (a) shows that when the vehicle 1 and the target vehicle 2 are located at the same positions as in FIG. 7, the distance between the end point T₁ of the lighting area A₁ of the headlamp 15 of the vehicle 1 and the end point G₁ of the lighting area C₁ of the headlamp of the target vehicle 2 is B₁. (b) shows that when the vehicle 1 and the target vehicle 2 move for a certain time as in FIG. 8, the distance between the end point T₂ of the lighting area A₂ of the headlamp 15 of the vehicle 1 and the end point G₂ of the lighting area C₂ of the headlamp of the target vehicle 2 is B₂′.

That is, as the vehicle 1 moves, the capturer 350 may detect S₁ more in terms of the lighting area irradiated from the headlamp of the target vehicle 2 onto the wall. Moreover, as the target vehicle 2 moves, the capturer 350 of the vehicle 1 may detect S₃ more in terms of the lighting area irradiated from the headlamp of the target vehicle 2 onto the wall.

Referring to FIG. 8, when the vehicle 1 moves the distance S₀ on the road for a predetermined time, a distance moved by the vehicle 1 along the trajectory on the wall is S₁. Since the circular road with a curved wall has a constant curvature, it may be assumed that the distance S₁ moved by the vehicle 1 along the trajectory on the wall is equal to the length S₂ that the end point of the lighting area of the headlamp 15 of the vehicle 1 is moved from T1 to T2.

As the vehicle 1 moves, the controller 100 may determine the length that the end point of the lighting area irradiated by the headlamp of the target vehicle 2 onto the wall is moved with respect to the end point of the lighting area of the headlamp 15 of the vehicle 1.

The controller 100 may determine the distance S₀ that the vehicle 1 moves on the road according to the equation 1, and the distance S₁ along the trajectory on the wall that the vehicle 1 moves according to the equation 2.

Furthermore, the controller 100 may determine a length of a change in lighting area of the headlamp of the target vehicle 2 that may be detected by the capturer 350 as the end point of the lighting area of the headlamp 15 of the vehicle 1 is moved from T₁ to T₂ and the end point of the lighting area of the headlamp of the target vehicle 2 is moved from G₁ to G₂, when the vehicle 1 and the target vehicle 2 move for a predetermined time.

For example, as the vehicle 1 and the target vehicle 2 move, the lighting area of the headlamp of the target vehicle 2 that may be detected by the capturer 350 increases by S₂+S₃.

Since the target vehicle 2 is stopped in FIG. 4, FIG. 5 and FIG. 6, as the vehicle 1 moves, the length S₂ of the lighting area of the headlamp of the target vehicle 2 that may be detected by the capturer 350 is the same as the distance S₁ moved along the trajectory on the wall of the driving road (i.e., S₁ and S₂ are assumed to be the same on the road with a constant curvature).

However, since even the target vehicle 1 is moving in FIGS. 7 to 9, as the vehicle 1 moves, the length S₂+S₃ of the lighting area of the headlamp of the target vehicle 2 that may be detected by the capturer 350 increases by S₃ as compared to the distance S₁ moved along the trajectory on the wall of the driving road.

The controller 100 may determine a difference S₂+S₃ between the distance B₂′ between the end point T₂ of the lighting area A₂ of the headlamp 15 of the vehicle 1 and the end point G₂ of the lighting area C2 of the headlamp of the target vehicle 2 after the vehicle 2 and the target vehicle 2 are driven for a predetermined time and the distance B₁ between the end point T₁ of the lighting area A₁ of the headlamp 15 of the vehicle 1 and the end point G₁ of the lighting area C₁ of the headlamp of the target vehicle 2 before the vehicle 1 is driven. Furthermore, the controller 100 may compare the difference S₂ with S₁ determined by the equations 1 and 2.

While the vehicle 1 and the target vehicle 2 are moving for a predetermined time, the length of the lighting area of the headlamp irradiated from the target vehicle 2 and detected by the capturer 350 of the vehicle 1 is changed more than is the distance S₁ moved along the trajectory of the vehicle 1 on the wall. In other words, the distance moved by the vehicle 1 along the trajectory on the wall is changed by S₁, but the lighting area irradiated from the headlamp of the target vehicle 2 and detected by the capturer 350 of the vehicle 1 increases by S₂+S₃.

Accordingly, the controller 100 may determine whether the target vehicle 2 is moving based on the difference between the length S₂ that the end point of the lighting area of the headlamp 15 of the vehicle 1 is moved and the length S₂+S₃ of a change in the lighting area of the headlamp of the target vehicle 2 detected by the capturer 350.

Since FIGS. 7 to 9 show an occasion when the target vehicle 2 is moving, the difference between the length S₁ that the end point of the lighting area of the headlamp 15 of the vehicle 1 is moved and the length S₂ of a change in lighting area of the headlamp of the target vehicle 2 detected by the capturer 350 becomes S₃.

The controller 100 may determine a risk level of collision between the vehicle 1 and the target vehicle 2, based on the difference as determined above.

When the vehicle 1 is driven at a high speed, an increase in the length S₂ that the end point of the lighting area of the headlamp of the vehicle 1 is moved increases. Furthermore, when the target vehicle 2 is driven at a high speed, an increase in the length S₂+S₃ of the change in lighting area of the headlamp of the target vehicle 2 detected by the capturer 350 increases as well. The higher the driving speed of the target vehicle 2, the larger an increase of S₃, and the controller 100 determines the risk level of collision between the vehicle 1 and the target vehicle 2 based on the magnitude of S₃. In other words, as the difference between the length that the end point of the lighting area of the headlamp 15 of the vehicle 1 is moved and the length of a change in lighting area of the headlamp of the target vehicle 2 captured by the capturer 350 increases, the risk level of collision between the vehicle 1 and the target vehicle 2 may be determined to be high.

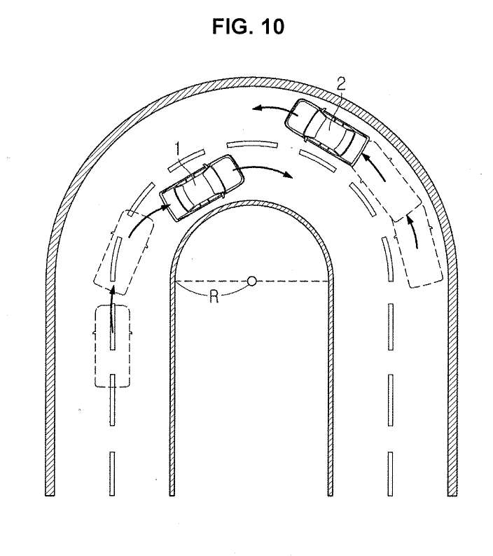

FIG. 10 shows controlling a driving route of a vehicle when there is a risk of the vehicle colliding with a target vehicle, according to an exemplary embodiment of the present invention.

Referring to FIG. 10, the controller 100 may determine a risk level of the vehicle 1 colliding with the target vehicle 2, and based on the risk level, send a signal to control the driving route of the vehicle 1.

The controller 100 may determine the risk level of collision by comparing a difference between the length that the end point of the lighting area of the headlamp 15 of the vehicle 1 is moved and the length of a change in lighting area of the headlamp of the target vehicle 2 captured by the capturer 350 with a predetermined value, and send a control signal for the vehicle 1 to avoid lane departure when the risk level of collision is higher than the predetermined value.

Furthermore, when the risk level of the vehicle 1 colliding with the target vehicle 2 is high and thus a collision with the target vehicle 2 is expected when the vehicle 1 moves round the road with a curved wall, the controller 100 may control steering of the vehicle 1 to stay in the original driving lane.

The controller 100 may send a signal to control the steering device 60 of the vehicle 1 for the vehicle 1 to stay in the driving lane, and based on the control signal, control the driving route of the vehicle 1 such that the vehicle 1 that is being driven out of the lane goes back to and stay in the lane, as shown in FIG. 10.

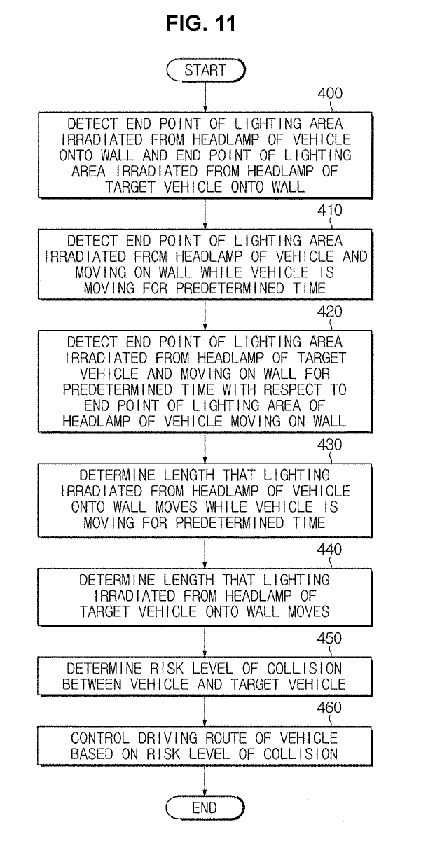

FIG. 11 is a flowchart illustrating a method for controlling a vehicle, according to an exemplary embodiment of the present invention.

Referring to FIG. 11, while the vehicle 1 is running on a road with a curved wall, the capturer 350 detects an end point of a lighting area irradiated from the headlamp 15 of the vehicle 1 onto the wall and an end point of a lighting area irradiated onto the wall from the headlamp of the target vehicle 2 running from the opposite direction, in 400.

The capturer 350 detects an end point of the lighting area irradiated from the headlamp 15 of the vehicle 1 and moving on the wall, while the vehicle 1 is running for a predetermined time, in 410. Furthermore, the capturer 350 detects an end point of the lighting area irradiated from the headlamp of the target vehicle 2 and moving on the wall for a predetermined time with respect to the end point of the lighting area of the headlamp 15 of the vehicle 1 moving on the wall, in 420.

As described above, when the target vehicle 2 is stopped, the end point of the lighting area irradiated from the headlamp of the target vehicle 2 is at a standstill, and otherwise when the target vehicle 2 is moving, the end point of the lighting area irradiated from the headlamp of the target vehicle 2 is changing as well.

The controller 100 may determine a distance traveled by the vehicle 1 based on the driving speed and time of the vehicle 1. When the vehicle 1 is driven for a predetermined time, the controller 100 determines a length that the lighting irradiated from the headlamp 15 of the vehicle 1 onto the wall moves, based on the distance traveled by the vehicle 1, the width of the vehicle 1, the lane width, and a turning radius of the road on which the vehicle 1 is moving, in 430.

Furthermore, the controller 100 determines a length that the end point of the lighting area of the headlamp of the target vehicle 2 detected on the wall moves for a predetermined time, based on a distance between the end point of the lighting area of the headlamp 15 of the vehicle 1 and the end point of the lighting area of the headlamp of the target vehicle 2, in 440.

The controller 100 determines a risk level of the vehicle 1 colliding with the target vehicle 2 based on a difference between the length that the end point of the lighting area of the headlamp 15 of the vehicle 1 moves and the length that the end point of the lighting area of the headlamp of the target vehicle 2 moves, in 450, and sends a signal to control the driving route of the vehicle 1 based on the risk level of collision, in 460.

When the difference between the length that the end point of the lighting area of the headlamp 15 of the vehicle 1 moves and the length that the end point of the lighting area of the headlamp of the target vehicle 2 moves is zero, the controller 100 may determine that the target vehicle 2 is stopped. Furthermore, when the risk level of collision is higher than a predetermined value, the controller 100 may expect that the vehicle 1 will collide with the target vehicle 2, and thus control the driving route of the vehicle 1 such that the vehicle 1 that is being driven out of the lane may go back to and stay in the lane, as shown in FIG. 10.

Of descriptions about the method for controlling the vehicle 1, what are already described above with reference to FIG. 4, FIG. 5, FIG. 6, FIG. 7, FIG. 8, and FIG. 9 are omitted.

According to embodiments of the present invention, a vehicle may perform collision avoidance control based on a change in lighting area of the headlamp of an approaching vehicle from the opposite direction, while traveling along a road with a wall having a large curvature including an accessway to an underground parking lot, moving up a control point of the existing lane keeping system or lane departure avoidance system and making the collision avoidance control more efficient.

Meanwhile, the embodiments of the present invention may be implemented in a form of recording media for storing instructions to be conducted by a computer. The instructions may be stored in a form of program codes, and when executed by a processor, may generate program modules to perform operation in the exemplary embodiments of the present invention. The recording media may correspond to computer-readable recording media.

The computer-readable recording medium includes any type of recording medium having data stored thereon that may be thereafter read by a computer. For example, it may be a ROM, a RAM, a magnetic tape, a magnetic disk, a flash memory, an optical data storage device, etc.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. the exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle running on a road with a curved wall, the vehicle comprising:
a speed detector configured to detect a driving speed of the vehicle;
a capturer configured to detect lighting irradiated from a headlamp of the vehicle onto the curved wall and lighting irradiated from a headlamp of a target vehicle onto the curved wall; and
a controller configured to determine a risk level of the vehicle colliding with the target vehicle based on a length that the lighting irradiated from the headlamp of the vehicle onto the curved wall moves and a length that the lighting irradiated from the headlamp of the target vehicle onto the curved wall moves when the vehicle is driven for a predetermined time, and control a driving route of the vehicle based on the determined risk level of collision.

2. The vehicle of claim 1, wherein the capturer is configured to detect an end point of a lighting area irradiated from the headlamp of the vehicle onto the curved wall and an end point of a lighting area irradiated from the headlamp of the target vehicle onto the curved wall.

3. The vehicle of claim 1, wherein the capturer is configured to detect an end point of a lighting area irradiated from the headlamp of the vehicle and moving on the curved wall while the vehicle is driven for the predetermined time, and wherein the capturer is configured to detect an end point of a lighting area irradiated from the headlamp of the target vehicle and moving on the curved wall for the predetermined time with respect to the end point of the lighting area of the headlamp of the vehicle moving on the curved wall.

4. The vehicle of claim 1,
wherein the controller is configured to determine a driving distance traveled by the vehicle based on the detected driving speed and a driving time of the vehicle.

5. The vehicle of claim 4,
wherein the controller is configured to determine a length that an end point of a lighting area irradiated from the headlamp of the vehicle onto the curved wall moves, based on the driving distance of the vehicle, a width of the vehicle, a width of a lane in which the vehicle is running, and a turning radius of the lane on which the vehicle is running.

6. The vehicle of claim 5,
wherein the controller is configured to determine a length that an end point of a lighting area of the headlamp of the target vehicle detected on the curved wall moves for the predetermined time, based on a distance between the end point of the lighting area of the headlamp of the vehicle and the end point of the lighting area of the headlamp of the target vehicle.

7. The vehicle of claim 6,
wherein the controller is configured to determine the risk level of the vehicle colliding with the target vehicle based on a difference between the length that the end point of the lighting area of the headlamp of the vehicle moves and the length that the end point of the lighting area of the headlamp of the target vehicle moves for the predetermined time.

8. The vehicle of claim 6,
wherein the controller is configured to determine that the target vehicle is at standstill when a difference between the length that the end point of the lighting area of the headlamp of the vehicle moves and the length that the end point of the lighting area of the headlamp of the target vehicle moves for the predetermined time is zero.

9. The vehicle of claim 1,
wherein the controller is configured to send a signal for lane departure avoidance control for the vehicle, when the determined risk level of collision is higher than a predetermined value.

10. A method for controlling a vehicle running on a road with a curved wall, the method comprising:
detecting lighting irradiated from a headlamp of the vehicle onto the curved wall and lighting irradiated from a headlamp of a target vehicle onto the curved wall;
determining a length that the lighting irradiated from the headlamp of the vehicle onto the curved wall moves while the vehicle is driven for a predetermined time;
determining a length that the lighting irradiated from the headlamp of the target vehicle onto the curved wall moves;
determining a risk level of the vehicle colliding with the target vehicle based on the length that the lighting irradiated from the headlamp of the vehicle onto the curved wall moves and the length that the lighting irradiated from the headlamp of the target vehicle onto the curved wall moves; and
controlling a driving route of the vehicle based on the determined risk level of collision.

11. The method of claim 10,
wherein detecting the lighting irradiated from the headlamp onto the curved wall includes:
detecting an end point of a lighting area irradiated from the headlamp of the vehicle onto the curved wall and an end point of a lighting area irradiated from the headlamp of the target vehicle onto the curved wall.

12. The method of claim 10,
wherein detecting the lighting irradiated from the headlamp onto the curved wall includes:
detecting an end point of a lighting area irradiated from the headlamp of the vehicle and moving on the curved wall, while the vehicle is driven for the predetermined time, and
detecting an end point of a lighting area irradiated from the headlamp of the target vehicle and moving on the curved wall for the predetermined time with respect to the end point of the lighting area of the headlamp of the vehicle moving on the curved wall.

13. The method of claim 10, further including:
detecting driving speed of the vehicle, and
determining a driving distance traveled by the vehicle based on the detected driving speed and a driving time of the vehicle.

14. The method of claim 13,
wherein determining the length that the lighting irradiated from the headlamp of the vehicle onto the curved wall moves includes:
determining a length that an end point of a lighting area irradiated from the headlamp of the vehicle onto the curved wall moves, based on the driving distance of the vehicle, a width of the vehicle, a width of a lane in which the vehicle is running, and a turning radius of the lane on which the vehicle is running.

15. The method of claim 14,
wherein determining the length that the lighting irradiated from the headlamp of the vehicle onto the curved wall moves includes:
determining a length that an end point of a lighting area of the headlamp of the target vehicle, detected on the curved wall moves for the predetermined time, based on a distance between the end point of the lighting area of the headlamp of the vehicle and the end point of the lighting area of the headlamp of the target vehicle.

16. The method of claim 15,
wherein determining the risk level of the vehicle colliding with the target vehicle includes:
determining a risk level of the vehicle colliding with the target vehicle based on a difference between the length that the end point of the lighting area of the headlamp of the vehicle moves and the length that the end point of the lighting area of the headlamp of the target vehicle moves for the predetermined time.

17. The method of claim 15,
wherein determining the risk level of the vehicle colliding with the target vehicle includes:
determining that the target vehicle is at standstill when a difference between the length that the end point of the lighting area of the headlamp of the vehicle moves and the length that the end point of the lighting area of the headlamp of the target vehicle moves for the predetermined time is zero.

18. The method of claim 10,
wherein controlling the driving route of the vehicle includes:
sending a signal for lane departure avoidance control for the vehicle, when the determined risk level of collision is higher than a predetermined value.
